(19) United States
(12) Patent Application Publication
(10) Pub. No.: US 2024/0305117 A1
(43) Pub. Date: Sep. 12, 2024

(54) BATTERY APPARATUS, CHARGER, AND ELECTRONIC EQUIPMENT

(71) Applicant: Sony Group Corporation, Tokyo (JP)

(72) Inventors: Yosuke MATSUZAKI, Tokyo (JP); Hiroki SATO, Tokyo (JP)

(73) Assignee: Sony Group Corporation, Tokyo (JP)

(21) Appl. No.: 18/256,928

(22) PCT Filed: Dec. 10, 2021
(86) PCT No.: PCT/JP2021/045478

§ 371 Date: Jun. 12, 2023

(30) Foreign Application Priority Data
Jan. 8, 2021 (JP) 2021-002108

(51) Int. Cl. H02J 7/00; H01M 10/46

(52) U.S. Cl. CPC H02J 7/0045; H01M 10/46; H01M 2220/20

(57) ABSTRACT

A battery apparatus includes a housing including a first exterior surface, a second exterior surface facing the first exterior surface, a third exterior surface and a fourth exterior surface provided between the first exterior surface and the second exterior surface and facing each other, and a fifth exterior surface and a sixth exterior surface provided between the first exterior surface and the second exterior surface and facing each other, a terminal portion including a connection terminal connected to an electrode terminal of connection equipment, a placement recessed portion provided in the one exterior surface and being open in a connection direction between the connection terminal and the electrode terminal, the terminal portion being placed in the placement recessed portion, multiple first guide recessed portion provided in one of the third exterior surface and the fourth exterior surface and being open in the connection direction.

### TECHNICAL FIELD

The present disclosure relates to a battery apparatus, a charger, and electronic equipment.

### BACKGROUND ART

Some of imaging apparatuses such as still cameras and video cameras and mobile bodies such as drones are made operative by power from a battery apparatus. Imaging apparatuses, mobile bodies, and the like operated by power from a battery apparatus will be described as battery driven equipment. The battery apparatus is charged, for example, by being installed in a charger.

The battery apparatus is provided with connection terminals including a positive electrode terminal, a negative electrode terminal, and the like. When the battery apparatus is installed in the charger or battery driven equipment, the connection terminals are connected to electrode terminals of the charger or the battery driven equipment to charge the battery apparatus or to supply power to the battery driven equipment.

When the battery apparatus is installed in the charger or the battery driven equipment, a user needs to align the battery apparatus at an installation position. When the alignment takes time, much time is required before the start of charging or power supply. Additionally, the battery apparatus may be brought into contact with any other structure, breaking or damaging the connection terminals.

### CITATION LIST

### Patent Literature

### [PTL 1]

Japanese Patent No. 6191795

### SUMMARY

### Technical Problem

The present disclosure provides a battery apparatus, a charger, and electronic equipment that enable the battery apparatus to be easily installed in connection equipment.

### Solution to Problem

A battery apparatus of the present disclosure includes a housing including a first exterior surface, a second exterior surface facing the first exterior surface, a third exterior surface and a fourth exterior surface provided between the first exterior surface and the second exterior surface and facing each other, and a fifth exterior surface and a sixth exterior surface provided between the first exterior surface and the second exterior surface and facing each other, a terminal portion including a connection terminal connected to an electrode terminal of connection equipment, a placement recessed portion provided in one of the third exterior surface and the fourth exterior surface and being open in a connection direction between the connection terminal and the electrode terminal, the terminal portion being placed in the placement recessed portion, multiple first guide recessed portions provided in the one of the third exterior surface and the fourth exterior surface and being open in the connection direction, a second guide recessed portion provided in the fifth exterior surface and being open in the connection direction, and a third guide recessed portion provided in the sixth exterior surface and being open in the connection direction.

A charger of the present disclosure includes an installation recessed portion including an installation surface in which a battery apparatus is installed, a first surface, a second surface, and a third surface at least partially surrounding the installation surface, the first surface being provided between the second surface and the third surface, a terminal portion provided on the installation surface and including an electrode terminal being connectible to a connection terminal of the battery apparatus, multiple first guide protruding portions provided on the first surface and having a longitudinal direction corresponding to a connection direction between the electrode terminal and the connection terminal, a second guide protruding portion provided on the second surface and having a longitudinal direction corresponding to the connection direction, and a third guide protruding portion provided on the third surface and having a longitudinal direction corresponding to the connection direction.

Electronic equipment of the present disclosure is electronic equipment including a battery installation portion in which a battery apparatus is installable, in which the battery installation portion includes an installation recessed portion including an installation surface in which the battery apparatus is installed, and a first surface, a second surface, and a third surface at least partially surrounding the installation surface, the first surface being provided between the second surface and the third surface, a terminal portion provided on the installation surface along the first surface and including an electrode terminal being connectible to a connection terminal of the battery apparatus, a first guide protruding portion provided on the second surface and having a longitudinal direction corresponding to a connection direction between the connection terminal and the electrode terminal, and a second guide protruding portion provided on the third surface and having a longitudinal direction corresponding to the connection direction.

### BRIEF DESCRIPTION OF DRAWINGS

FIG. 1 is a perspective view schematically depicting an example of a battery apparatus and a charger of the battery apparatus according to the present embodiment.

FIG. 2 is a perspective view of the battery apparatus as seen from a rear surface side.

FIG. 3 is a partially enlarged view of a left side surface of the battery apparatus.

FIG. 4 is a partially enlarged view of a rear surface of the battery apparatus.

FIG. 5 is an enlarged perspective view of the charger.

FIG. 6 is a block diagram of electronic equipment according to the present embodiment.

FIG. 7 is a perspective view schematically depicting an example of a battery installation portion of the electronic equipment according to the present embodiment.

FIG. 8 is an external perspective view depicting the battery apparatus being installed in the battery installation portion of the electronic equipment.

### DESCRIPTION OF EMBODIMENTS

Embodiments of the present disclosure will be described below with reference to the drawings. In one or more embodiments illustrated in the present disclosure, elements included in each embodiment can be combined together, and deliverables resulting from the combination constitute a part of the embodiments illustrated in the present disclosure.

A battery apparatus and equipment (connection equipment) in or to which the battery apparatus is installed or connected will be described below. The battery apparatus is formed generally like a rectangular parallelopiped, and outer surfaces (exterior surfaces) of the battery apparatus are an upper surface (top surface), a lower surface (bottom surface), side surfaces (both left and right side surfaces), a front surface, and a rear surface, indicating a forward direction, a rearward direction, an upward direction, a downward direction, a leftward direction, and a rightward direction.

A height direction refers to a direction from one of the upper surface and the lower surface to the other. A width direction refers to a direction from one of both the left and right side surfaces to the other. A thickness direction refers to a direction from one of the front surface and the rear surface to the other.

The upper, lower, side, front, and rear surfaces are not limited to flat surfaces, and may be at least partially bent. The present disclosure is not limited to the above-described definitions of the height direction, the width direction, and the thickness direction, and the like, and, for example, the definitions of the width direction and the thickness direction may be reversed.

Additionally, a charger and electronic equipment will be described below as examples of connection equipment to which the battery apparatus is connected. Examples of the electronic equipment include a mobile body such as a drone and an imaging apparatus such as a camera. However, the present disclosure is not limited to these types of electronic equipment.

The charger is provided with a battery installation portion having a recessed shape in which the battery apparatus is installed or inserted. In the charger, an installation direction or a connection direction refers to a direction in which the battery apparatus is inserted.

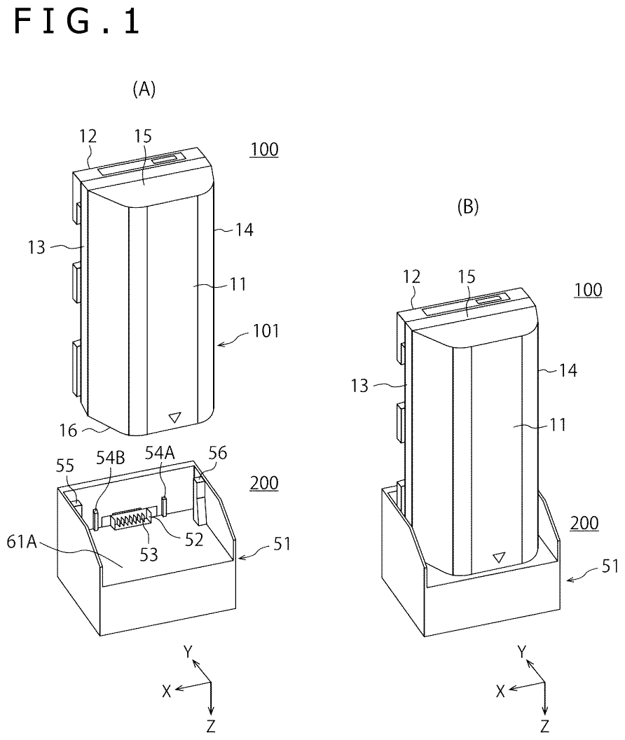

FIG. 1 is a perspective view schematically depicting an example of a battery apparatus 100 according to the present embodiment and a charger 200 in which the battery apparatus 100 is installed. FIG. 1(A) depicts a state before the battery apparatus 100 is installed in the charger 200. FIG. 1(B) depicts a state with the battery apparatus 100 installed in the charger 200.

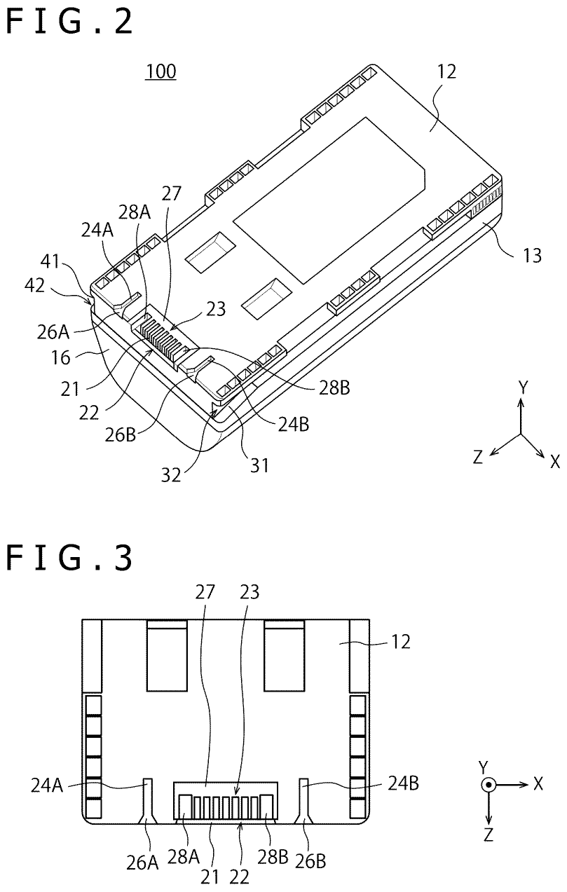

FIG. 2 is a perspective view of the battery apparatus 100 as seen from a rear surface 12 side.

FIG. 3 is a partially enlarged view of the rear surface 12 of an installation direction side of the battery apparatus 100.

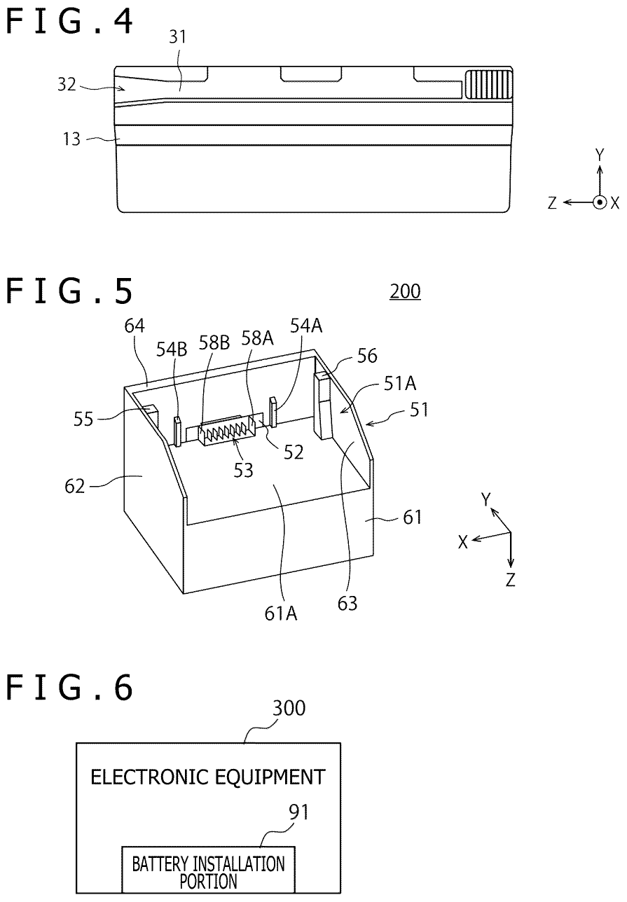

FIG. 4 is a partially enlarged view of a left side surface 13 of the installation direction side of the battery apparatus 100.

FIG. 5 is an enlarged perspective view of the charger 200.

In FIG. 1, the battery apparatus 100 can be installed in the charger 200, and the battery apparatus 100 can be charged by the charger 200 while being installed in the charger 200. When the battery apparatus 100 is charged, the battery apparatus 100 is removed from electronic equipment 300 (see FIG. 6), and the removed battery apparatus 100 is installed in the charger 200. While being installed in the charger 200, the battery apparatus receives power from the charger 200 to charge a secondary cell (battery) with the received power.

The battery apparatus 100 includes a housing (battery housing) 101 generally shaped like a box, a battery (not illustrated) built into the battery housing 101, and a terminal portion 27 (see FIG. 2) including a connection terminal 23 that can be connected to an electrode terminal of the charger 200. As an example, the battery housing 101 includes a dielectric such as plastic. The battery includes multiple secondary cells connected together in series, in parallel, or in series parallel. The battery apparatus 100 is configured as a battery pack with a battery built therein.

The battery housing 101 includes, as multiple exterior surfaces, a front surface 11, a rear surface 12, a left side surface 13, a right side surface 14, an upper surface 15, and a lower surface 16. The left side surface 13 and the right side surface 14 are provided between the upper surface 15 and the lower surface 16 and face each other. The front surface 11 and the rear surface 12 are provided between the upper surface 15 and the lower surface 16 and face each other.

One of a first exterior surface and a second exterior surface corresponds to the upper surface 15, whereas the other corresponds to the lower surface 16. One of a third exterior surface and a fourth exterior surface corresponds to the front surface 11, whereas the other corresponds to the rear surface 12. One of a fifth exterior surface and a sixth exterior surface corresponds to the left side surface 13, whereas the other corresponds to the right side surface 14.

The figure represents an XYZ coordinate system. A direction parallel to an X axis corresponds to a width direction, a direction parallel to a Y axis corresponds to a thickness direction, and a direction parallel to a Z axis corresponds to a height direction. In particular, a positive direction of the Z axis corresponds to an installation direction (or connection direction) of the battery apparatus 100. A negative direction of the Z axis corresponds to a detachment direction of the battery apparatus 100.

As depicted in FIG. 2 and FIG. 3, a placement recessed portion 21 is provided on the rear surface 12 of the battery housing 101 in such a manner as to be open in the installation direction. The placement recessed portion 21 is provided at an end of the rear surface 12 in the installation direction. The placement recessed portion 21 is a recessed portion in which the terminal portion 27 is placed or housed. The placement recessed portion 21 includes an opening portion 22 extending in the installation direction.

The placement recessed portion 21 is provided with the terminal portion 27. The terminal portion 27 has a recessed shape that can hold the electrode terminal of the charger 200 from opposite sides, and includes a connection terminal 23 that can be electrically connected to the electrode terminal. As an example, the connection terminal 23 includes a positive electrode terminal, a negative electrode terminal, and an information terminal. However, the connection terminal 23 may include no information terminal. When the battery apparatus 100 is installed, an electrode terminal 53 (see FIG. 5) of a terminal portion 52 of the charger 200, the electrode terminal 53 having a protruding shape, is press-fitted in the recessed portion of the connection terminal 23 to fit the connection terminal 23 with the electrode terminal 53. Thus, the terminal portion 27 and the terminal portion 52 are coupled to electrically connect the connection terminal 23 and the electrode terminal 53. Specifically, the positive electrode terminal of the connection terminal 23 is electrically connected to the positive electrode terminal of the electrode terminal 53. The negative electrode terminal of the connection terminal 23 is electrically connected to the negative electrode terminal of the electrode terminal 53. The information terminal of the connection terminal 23 is electrically connected to the information electrode terminal of the electrode terminal 53. The terminal portion 27 is provided with recessed portions 28A and 28B at opposite ends of the terminal portion 27 in the X axis direction. Protruding portions 58A and 58B (see FIG. 5) at opposite ends of the terminal portion 52 of the charger 200 are inserted into the recessed portions 28A and 28B. This facilitates stabilization of a connection state between the electrode terminal 53 and the connection terminal 23 or a coupling state between the terminal portion 27 of the battery apparatus 100 and the terminal portion 52 of the charger 200.

While being installed in the charger 200, the battery apparatus 100 can receive power from the charger 200 via the positive electrode terminal and the negative electrode terminal and can transmit and receive information to and from the charger 200. As an example of information transmission and reception, the battery apparatus 100 transmits, to the charger 200, information indicating the state of the battery, for example, information indicating the state of charge. Additionally, the battery apparatus 100 may transmit or receive, to or from the charger 200, control information related to charging. Examples of the control information include information for notification of the start or end of charging, information indicating a charging voltage value, information indicating a charging current value, and the like.

In FIG. 2 or FIG. 3, the battery apparatus 100 includes, in the rear surface 12, multiple (in the present example, two) guide recessed portions 24A and 24B (first guide recessed portions) that are open in the installation direction. The guide recessed portions 24A and 24B are provided at positions away from the opposite sides of the placement recessed portion 21 in a direction parallel to the X axis. The guide recessed portions 24A and 25B include opening portions 26A and 26B extending in the installation direction. A configuration is not excluded in which the guide recessed portions 24A and 24B are provided on one side of the placement recessed portion 21 rather than on both sides of the placement recessed portion 21. The number of the first guide recessed portions may be three or more or may be one. The guide recessed portions 24A and 24B have a shape extending in a direction parallel to the installation direction of the battery apparatus 100.

Multiple guide protruding portions 54A and 54B (first guide protruding portion) (see FIG. 1) of the charger 200 can be inserted or slid through the guide recessed portions 24A and 24B. Additionally, the opening areas of the opening portions 26A and 26B spread in the installation direction (Z axis direction) of the battery apparatus 100. Thus, the opening portions 26A and 26B function as rough guides for alignment with the battery apparatus 100. Consequently, the guide recessed portions 24A and 24B function as positioning slits with rough guides in the width direction (direction parallel to the X axis). When the battery apparatus 100 is installed, the guide protruding portions 54A and 54B (see FIG. 1 or FIG. 5) of the charger 200 are aligned by the opening portions 26A and 26B of the battery apparatus 100 and then inserted into the guide recessed portions 24A and 24B succeeding the opening portions 26A and 26B. Note that, in the present example, the opening areas of both the opening portion 26A and the opening portion 26B spread in the installation direction but that the opening area of one of the opening portion 26A and the opening portion 26B may exclusively spread in the installation direction of the battery apparatus 100.

As depicted in FIG. 2 and FIG. 4, the battery apparatus 100 includes a guide recessed portion 31 (second guide recessed portion) provided in the left side surface 13 and being open in the installation direction of the battery apparatus 100. The guide recessed portion 31 is provided at an end of the left side surface 13 in the installation direction of the battery apparatus 100. The guide recessed portion 31 includes an opening portion 32 extending in the installation direction of the battery apparatus 100. The guide recessed portion 31 has a shape extending in a direction parallel to the installation direction of the battery apparatus 100.

The right side surface 14 opposite to the left side surface 13 of the battery apparatus 100 also includes a structure similar to that in the left side surface 13. Specifically, as depicted in FIG. 2, the battery apparatus 100 includes a guide recessed portion 41 (third guide recessed portion) provided in the right side surface 14 of the battery apparatus 100, the guide recessed portion 41 being open in the installation direction of the battery apparatus 100. The guide recessed portion 41 is provided at an end of the right side surface 14 in the installation direction. The guide recessed portion 41 includes an opening portion 42 extending in the installation direction. The guide recessed portion 41 has a shape extending in a direction parallel to the installation direction of the battery apparatus 100. As an example, the structure in the left side surface 13 and the structure in the right side surface 14 are symmetric with respect to a line (central axis) extending through the center of the battery apparatus 100 along the Z axis direction.

A guide protruding portion 55 (second guide protruding portion) and a guide protruding portion 56 (third guide protruding portion) of the charger 200 can be inserted into or slid through the guide recessed portion 31 and the guide recessed portion 41 in the opposite side surfaces of the battery apparatus 100. Additionally, the opening areas of the opening portions 32 and 42 spread in the installation direction of the battery apparatus 100. Thus, the opening portions 32 and 42 function as rough guides for installation of the battery apparatus 100. Consequently, the guide recessed portion 31 and the guide recessed portion 41 function as positioning slits with rough guides in a direction parallel to the Y axis (thickness direction). When the battery apparatus 100 is installed, the guide protruding portions 55 and 56 of the charger 200 are aligned by the opening portions 32 and 42 of the battery apparatus 100 and then inserted into the guide recessed portions 31 and 41 succeeding the opening portions 32 and 42. Note that, in the present example, the opening areas of both the opening portions 32 and 42B spread in the installation direction of the battery apparatus 100 but that the opening area of one of the opening portions 32 and 42B may exclusively spread in the installation direction of the battery apparatus 100.

As depicted in FIG. 5, the charger 200 includes a battery installation portion 51 in or to which the battery apparatus 100 is installed or connected. The battery installation portion 51 includes an installation recessed portion 51A that is a recessed portion in which the battery apparatus 100 is installed or housed. The charger 200 is connected to an external power supply (not illustrated) via a cable or the like, and is configured to enable charging of the battery apparatus 100 installed in the charger 200. The charger 200 includes, inside a housing (base) 61, a power supply circuit (not illustrated) that receives power from an external power supply. The external power supply supplying power to the charger 200 may be a commercial power supply or an electric storage apparatus. In a case where the external power supply is an electric storage apparatus, the electric storage apparatus may be built into the housing 61 of the charger 200. The external power supply may be an AC power supply or a DC power supply. For an AC power supply, the power supply circuit of the charger 200 converts an AC voltage supplied from the AC power supply into a DC voltage adjusted to a rated value of the battery apparatus 100, and charges the battery apparatus 100 with the DC voltage resulting from the conversion.

As an example, the housing 61 of the charger 200 includes a dielectric such as plastic. The housing 61 includes an installation surface 61A that is a front surface of a base of the housing 61, and a rear surface portion 64, a right side portion 63, and a left side portion 62 which surround the installation surface 61A. The left side portion 62, the right side portion 63, and the rear surface portion 64 protrude upward (Z axis negative direction). The installation recessed portion 51A includes an installation surface 61A, and a first surface, a second surface, and a third surface which at least partially surround the installation surface 61A. In this case, as an example, the first surface corresponds to a surface on a Y axis negative direction side of the rear surface portion 64. The second surface corresponds to a surface on an X axis direction side of the right side portion 63. The third surface corresponds to a surface on an X axis negative direction side of the left side portion 62. The first surface is provided between the second surface and the third surface. The installation recessed portion 51A includes an opening in which the battery apparatus 100 is housed, the battery apparatus 100 being inserted in a direction parallel to the height direction (direction parallel to the Z axis direction).

The installation surface 61A of the base 61 is provided with the terminal portion 52 with the electrode terminal 53 that can be connected to the connection terminal 23 of the battery apparatus 100. The terminal portion 52 is provided near the center of an end on the rear surface portion 64 side of the installation surface 61A. A surface on the rear surface portion 64 of the terminal portion 52 is coupled to the rear surface portion 64, and thus the terminal portion 52 is integrally formed extending across both the installation surface 61A and the rear surface portion 64. However, in a possible configuration, the terminal portion 52 is separate from one of the rear surface portion 64 or the installation surface 61A.

The terminal portion 52 includes the electrode terminal 53 having a protruding shape. As an example, the electrode terminal 53 includes a positive electrode terminal, a negative electrode terminal, and an information terminal. The electrode terminal 53 may include no information terminal. When the electrode terminal 53 is press-fitted in the connection terminal 23 of the battery apparatus 100, which has a recessed shape, the electrode terminal 53 is fitted to the connection terminal 23 to electrically connect the connection terminal 23 and the electrode terminal 53. As described above, the terminal portion 52 is provided with the protruding portions 58A and 58B at the opposite ends of the terminal portion 52, and when the battery apparatus 100 is installed, the protruding portions 58A and 58B can be inserted (fitted) into the recessed portions 28A and 28B at the opposite ends of the terminal portion 27 of the battery apparatus 100. This facilitates stabilization of the connection state between the connection terminal 23 and the electrode terminal 53 or the coupling state between the terminal portion 27 of the battery apparatus 100 and the terminal portion 52 of the charger 200. Note that a possible configuration may omit the protruding portions 58A and 58B at the opposite ends of the terminal portion 52 and the recessed portions 28A and 28B at the opposite ends of the terminal portion 27. The rear surface portion 64 of the base 61 is provided with multiple (in the present example, two) guide protruding portions 54A and 54B (first guide protruding portions). The guide protruding portions 54A and 54B have a longitudinal direction corresponding to the connection direction of the battery apparatus 100. That is, each of the guide protruding portions 54A and 54B has a generally square shape extending linearly in a direction parallel to the Z axis. The guide protruding portions 54A and 54B are provided at positions away from the opposite sides of the terminal portion 52 in a direction parallel to the X axis direction. Lower surfaces of the guide protruding portions 54A and 54B in the Z axis direction are coupled to the installation surface 61A. The guide protruding portions 54A and 54B are integrally formed extending across both the installation surface 61A and the rear surface portion 64. However, the guide protruding portions 54A and 54B may be separate from one of the installation surface 61A or the rear surface portion 64. The length of each of the guide protruding portions 54A and 54B in the width direction (X axis direction) is equal to or less than the length of each of the guide recessed portions 24A and 24B in the X axis direction. Thus, the guide protruding portions 54A and 54B can be inserted into (slid through) the guide recessed portions 24A and 24B via the opening portions 26A and 26B of the battery apparatus 100.

The left side portion 62 and the right side portion 63 of the base 61 are respectively provided with the guide protruding portion 55 (second guide protruding portion) and the guide protruding portion 56 (third guide protruding portion). The guide protruding portions 55 and 56 have a longitudinal direction corresponding to the connection direction of the battery apparatus 100. Each of the guide protruding portions 55 and 56 has a generally square shape extending linearly in a direction parallel to the Z axis. The guide protruding portions 55 and 56 are larger in length (height) than the guide protruding portions 54A and 54B on the opposite sides of the terminal portion 52. The guide protruding portion 55 and the guide protruding portion 56 are provided at positions away from the guide protruding portions 54A and 54B and the terminal portion 52. Additionally, the guide protruding portion 55 and the guide protruding portion 56 are located outside the guide protruding portions 54B and 54A in the width direction (direction parallel to the X axis) of the battery apparatus 100. The guide protruding portion 55 and the guide protruding portion 56 are opposite each other in the width direction of the battery apparatus 100 (as an example, the guide protruding portions 55 and 56 have the same Y axis coordinate). However, in a possible configuration, the guide protruding portion 55 and the guide protruding portion 56 are not opposite each other in the width direction of the battery apparatus 100 (as an example, the guide protruding portions 55 and 56 have different Y axis coordinates).

A lower surface of the guide protruding portion 55 in the Z axis direction is coupled to the installation surface 61A, and thus the guide protruding portion 55 is integrally formed extending across both the left side portion 62 and the installation surface 61A. A lower surface of the guide protruding portion 56 in the Z axis direction is coupled to the installation surface 61A, and thus the guide protruding portion 56 is integrally formed extending across both the right side portion 63 and the installation surface 61A. However, in a possible configuration, the guide protruding portion 55 is separate from one of the left side portion 62 or the installation surface 61A. Additionally, in a possible configuration, the guide protruding portion 56 is separate from one of the right side portion 63 or the installation surface 61A.

The length of the guide protruding portion 55 in the Y axis direction is equal to or less than the length of the guide recessed portion 31 in the Y axis direction. Thus, the guide protruding portion 55 can be inserted into (slid through) the guide recessed portion 31 via the opening portion 32 of the battery apparatus 100. Similarly, the length of the guide protruding portion 56 in the Y axis direction is equal to or less than the length of the guide recessed portion 41 of the right side surface 14 of the battery apparatus 100 in the Y axis direction. Thus, the guide protruding portion 56 can be inserted into (slid through) the guide recessed portion 41 via the opening portion 42 of the battery apparatus 100.

With reference to FIG. 1 and FIG. 2, an example of a procedure for installing the battery apparatus 100 in the charger 200 will be described. When the battery apparatus 100 is installed in the charger 200, the user places the lower surface 16 of the battery apparatus 100 opposite to the installation surface 61A of the battery installation portion 51. In this state, while aligning the battery apparatus 100 with the charger 200 in the width direction and the thickness direction, the user moves the battery apparatus 100 in the installation direction or the connection direction.

More specifically, first, with the opening portions 32 and 42 (see FIG. 2) on the opposite sides of the battery apparatus 100 acting as rough guides for positioning in the thickness direction (direction parallel to the Y axis), positioning in the thickness direction is performed via the guide protruding portions 55 and 56 of the charger 200. After the positioning in the thickness direction, the user slightly slides the battery apparatus in the installation direction. Then, with the opening portions 26A and 26B acting as rough guides for positioning in the width direction (direction parallel to the X axis), positioning in the width direction is performed via the guide protruding portions 54A and 54B of the charger 200. This facilitates the alignment in the thickness direction and the width direction.

The user further slides the battery apparatus 100 in the installation direction. That is, the guide protruding portions 55 and 56 of the charger 200 are slid through the guide recessed portions 31 and 41 of the battery apparatus 100, and the guide protruding portions 54A and 54B of the charger 200 are slid through the guide recessed portions 24A and 24B of the battery apparatus 100. When the electrode terminal 53 of the charger 200 comes into abutting contact with the recessed opening portion of the connection terminal 23, the user applies a stronger force in the installation direction to press-fit the electrode terminal 53 into the recessed opening portion of the connection terminal 23. Thus, the electrode terminal 53 is fitted to the connection terminal 23 to electrically connect the connection terminal 23 to the electrode terminal 53. The position of the battery apparatus 100 is fixed, and the installation of the battery apparatus 100 is complete. This state corresponds to the state depicted in FIG. 1(B).

In a case where the user removes the battery apparatus 100 from the charger 200, a procedure opposite to the installation may be performed. That is, the user pulls the battery apparatus 100 in a direction (Z axis negative direction) opposite to the installation direction (or the connection direction) to detach the connection terminal 23 from the terminal portion 52 of the charger 200. Thus, the user can remove the battery apparatus 100 from the charger 200.

FIG. 6 is a block diagram of electronic equipment 300 according to the present embodiment.

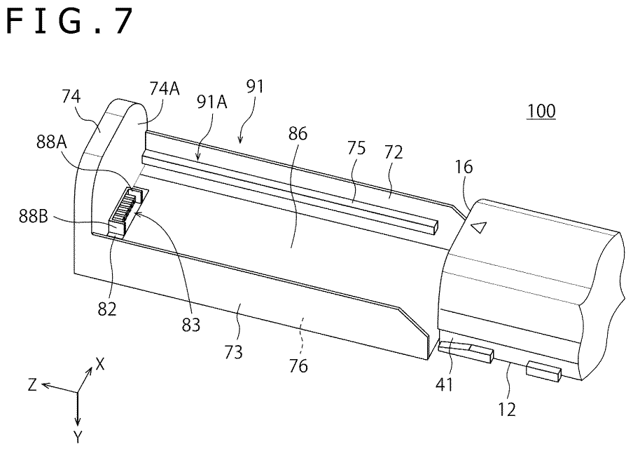

FIG. 7 is a perspective view schematically depicting a battery installation portion 91 of the electronic equipment 300 in FIG. 6.

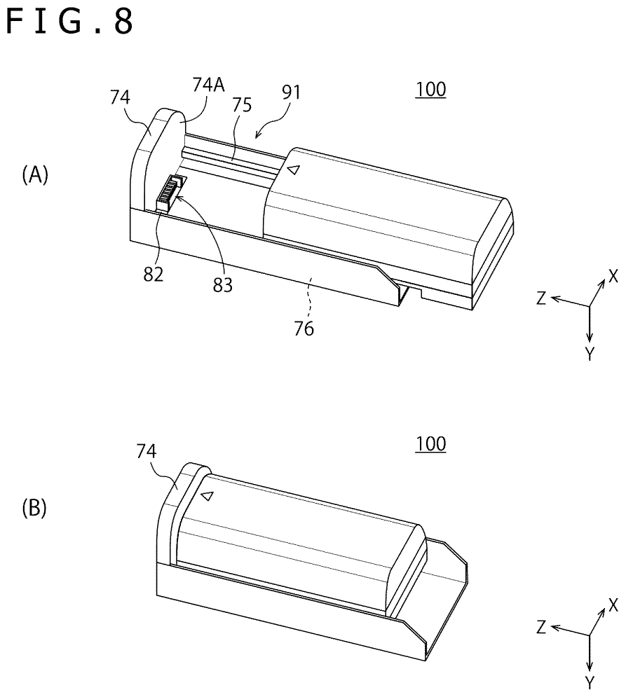

FIG. 8 is an external perspective view depicting the battery apparatus 100 being installed in the battery installation portion 91 of the electronic equipment. FIG. 8(A) depicts the installation being under way, and FIG. 8(B) depicts the installation being complete.

The electronic equipment 300 depicted in FIG. 6 is a mobile body such as a drone, a robot, or an AGV (Automatic Guided Vehicle), and an imaging apparatus such as a still camera or a video camera. The electronic equipment 300 includes the battery installation portion 91 in which the battery apparatus 100 is installed. While being installed in the battery installation portion 91, the battery apparatus 100 can supply power to the electronic equipment 300 by discharging power from the battery. When power is supplied to the electronic equipment 300, the battery apparatus 100 is removed from the charger 200, and the removed battery apparatus 100 is installed in the battery installation portion 91 of the electronic equipment. While being installed in the battery installation portion 91, the battery apparatus 100 discharges power from the battery to supply the power to the electronic equipment 300.

When the battery apparatus 100 is installed in the battery installation portion 91 of the electronic equipment 300, positioning in the thickness direction (direction parallel to the Y axis) is performed using the opening portion 32 of the guide recessed portion 31 and the opening portion 42 of the guide recessed portion 41 of the battery apparatus 100. However, positioning in the width direction (direction parallel to the X axis) is not performed using the opening portion 26A of the guide recessed portion 24A and the opening portion 26B of the guide recessed portion 24B of the battery apparatus 100.

The battery installation portion 91 of the electronic equipment is configured similarly to the battery installation portion 51 of the charger 200. However, the battery installation portion 91 does not perform the positioning in the width direction, and thus has no configuration corresponding to the guide protruding portions 54A and 54B of the charger 200. For the remaining configurations, the battery installation portion 91 of the electronic equipment is similar to the battery installation portion 51 of the charger except for a configuration attributed to the role between the charger 200 and the electronic equipment. Further details will be provided below.

As depicted in FIG. 7, the battery installation portion 91 of the electronic equipment includes an installation recessed portion 91A that is a recessed portion in which the battery apparatus 100 is installed or housed. The battery installation portion 91 is connected to a power supply circuit (not illustrated) of the electronic equipment via wiring or the like, and is configured to enable power (for example, DC power) supplied from the battery apparatus 100 to be supplied to the electronic equipment.

As an example, a housing of the battery installation portion 91 includes a dielectric such as plastic. The battery installation portion 91 includes a mounting portion (base) 74 in which the battery apparatus 100 is installed. A surface on a Z axis negative direction side of the mounting portion (base) 74 corresponds to an installation surface 74A. A left side portion 72, a right side portion 73, and a rear surface portion 86 that at least partially surround the mounting portion 74 are provided. With respect to the mounting portion 74, the left side portion 72 and the right side portion 73 protrude in the Y axis negative direction, and the rear surface portion 86 protrudes in the Z axis negative direction. The installation recessed portion 91A of the battery installation portion 91 includes the installation surface 74A and a first surface, a second surface, and a third surface at least partially surrounding the installation surface 74A. In this case, as an example, the first surface corresponds to an inner side surface (surface on the Y axis negative direction side) of the rear surface portion 86. The second surface corresponds to an inner side surface (surface on the X axis negative direction side) of the left side portion 72. The third surface corresponds to an inner side surface (surface on the X axis direction side) of the right side portion 73. The first surface is provided between the second surface and the third surface. The mounting portion 74, the left side portion 72, the right side portion 73, and the rear surface portion 86 form an opening in which the battery apparatus 100 inserted in the height direction (direction parallel to the Z axis direction) is housed.

The installation surface 74A of the mounting portion 74 is provided with a terminal portion 82 along the inner side surface of the rear surface portion 86 (surface on the Y axis negative direction side). The terminal portion 82 is provided near the center of an end of the mounting portion 74 in the Y axis direction. A surface on the Y axis direction side of the terminal portion 82 is coupled to the rear surface portion 86, and thus the terminal portion 82 is integrally formed extending across both the mounting portion 74 and the rear surface portion 86. However, the terminal portion 82 may be separate from one of the mounting portion 74 or the rear surface portion 86.

The terminal portion 82 includes an electrode terminal 83 having a protruding shape and that can be connected to the connection terminal of the battery apparatus 100. As an example, the electrode terminal 83 includes a positive electrode terminal, a negative electrode terminal, and an information terminal. The electrode terminal 83 may include no information terminal. When the electrode terminal 83 is press-fitted in the connection terminal 23 of the battery apparatus 100, the connection terminal 23 having a recessed shape, the electrode terminal 83 is electrically connected to the connection terminal 23. The terminal portion 82 is provided with protruding portions 88A and 88B at the opposite ends of the terminal portion 82, and when the battery apparatus 100 is installed, the protruding portions 88A and 88B are inserted into the recessed portions 28A and 28B at the opposite ends of the terminal portion 27 of the battery apparatus 100. This facilitates stabilization of the connection state between the connection terminal 23 and the electrode terminal 83 or the coupling state between the terminal portion 27 of the battery apparatus 100 and the terminal portion 82 of the battery installation portion 91. Note that a possible configuration may omit the protruding portions 88A and 88B at the opposite ends of the terminal portion 82 and the recessed portions 28A and 28B at the opposite ends of the terminal portion 27.

An inner side surface (surface in the X axis negative direction) of the left side portion 72 is provided with a guide protruding portion 75 (first guide protruding portion). The guide protruding portion 75 has a longitudinal direction corresponding to the connection direction of the battery apparatus 100. That is, the guide protruding portion 75 has a generally square shape extending linearly in a direction parallel to the Z axis. Similarly, an inner side surface (surface in the X axis direction) of the right side portion 73 is provided with a guide protruding portion 76 (second guide protruding portion). The guide protruding portion 76 has a longitudinal direction corresponding to the connection direction of the battery apparatus 100. The guide protruding portion 76 has a generally square shape extending linearly in a direction parallel to the Z axis. The guide protruding portions 75 and 76 are formed at a certain height from the inner side surface of the rear surface portion 86 in the Y axis negative direction.

The width of the guide protruding portion 75 in the Y axis direction is equal to or less than the width of the guide recessed portion 31 of the battery apparatus 100 in the Y axis direction. The width of the guide protruding portion 76 in the Y axis direction is equal to or less than the width of the guide recessed portion 41 of the battery apparatus 100 in the Y axis direction. The guide protruding portion 75 and the guide protruding portion 76 face each other in the width direction of the battery apparatus 100 (direction parallel to the X axis). As an example, the height of the guide protruding portion 75 from the inner side surface of the rear surface portion 86 is the same as the height of the guide protruding portion 76 from the inner side surface of the rear surface portion 86. However, the present disclosure is not limited to this configuration.

When the battery apparatus 100 is installed, the user places the rear surface 12 opposite to the rear surface portion 86, while placing the lower surface 16 of the battery apparatus 100 opposite to the installation surface 74A. In this state, the user aligns the battery apparatus 100 with the guide protruding portion 75 and the guide protruding portion 76 in the thickness direction (direction parallel to the Y axis) using the opening portions 32 and 42 of the battery apparatus 100 as rough guides. After the alignment, while sliding the guide recessed portions 31 and 41 of the battery apparatus 100 over the guide protruding portion 75 and the guide protruding portion 76, the user moves the battery apparatus 100 in the installation direction (see FIG. 8(A)).

When the electrode terminal 83 of the battery installation portion 91 comes into abutting contact with the recessed opening portion of the connection terminal 23 of the battery apparatus 100, the user applies a stronger force in the installation direction to press-fit the electrode terminal 83 of the battery installation portion 91 into the recessed opening portion of the connection terminal 23. The connection terminal 23 and the electrode terminal 83 are fitted to each other to electrically connect the connection terminal 23 to the electrode terminal 83. The position of the battery apparatus 100 is fixed, and the installation of the battery apparatus 100 is complete. This state corresponds to the state depicted in FIG. 8(B).

In a case where the user removes the battery apparatus 100 from the battery installation portion 91 of the electronic equipment, a procedure opposite to the installation may be performed. That is, the user pulls the battery apparatus 100 in a direction (Z axis negative direction) opposite to the installation direction to detach the connection terminal 23 from the terminal portion 82 of the battery installation portion 91. Thus, the user can remove the battery apparatus 100 from the charger 200.

In the example illustrated in FIG. 7 and FIG. 8, the battery installation portion 91 of the electronic equipment is provided with no protruding portions corresponding to the guide recessed portions 24A and 24B of the battery apparatus 100, and the battery apparatus 100 is not positioned in the width direction (direction parallel to the X axis). However, the terminal portion 82 of the battery installation portion 91 may include protruding portions provided on the opposite sides of the terminal portion 82 and corresponding to the guide recessed portions 24A and 24B of the battery apparatus 100, and the battery apparatus 100 may be aligned in the width direction (direction parallel to the X axis).

### (Variation 1)

In the configuration of the charger 200 in the embodiment described above, each of the guide protruding portions 55 and 56 is larger in length (height) in the longitudinal direction than each of the guide protruding portions 54A and 54B. However, in a possible configuration, each of the guide protruding portions 54A and 54B is larger in length in the longitudinal direction than each of the guide protruding portions 55 and 56. Thus, when the battery apparatus 100 is installed in the charger 200, the positioning of the battery apparatus 100 in the width direction can be performed before the positioning of the battery apparatus 100 in the thickness direction.

### (Variation 2)

In the embodiment described above, the recessed portions in one of the battery apparatus 100 or the charger 200 may be replaced with protruding portions, whereas the protruding portions in the other may be replaced with recessed portions, and vice versa. For example, the guide protruding portions 54A and 54B of the charger 200 may be replaced with recessed portions, whereas the guide recessed portions 24A and 24B of the battery apparatus 100 may be replaced with protruding portions. Similarly, the guide protruding portions 55 and 56 of the charger 200 may be replaced with recessed portions, whereas the guide recessed portions 31 and 41 of the battery apparatus 100 may be replaced with protruding portions.

Additionally, similarly, the recessed portions in one of the battery apparatus 100 or the battery installation portion 91 may be replaced with protruding portions, whereas the protruding portions in the other may be replaced with recessed portions, and vice versa.

### (Variation 3)

The transmission of power between the battery apparatus 100 and the charger 200 may be wireless power transmission. In this case, the connection terminal 23 of the battery apparatus 100 and the electrode terminal 53 of the charger 200 are unnecessary. The terminal portion 27 of the battery apparatus 100 is only required to be replaced with a wireless power transmission section (wireless power receiving section), and the terminal portion 52 of the charger 200 is only required to be replaced with a wireless power transmission section (wireless power transmitting section). As an example, the wireless power receiving section and the wireless power transmitting section can each include a resonator including a coil and a capacitor. By magnetically coupling the resonator of the wireless power transmitting section and the resonator of the wireless power receiving section using mutual inductance of the coils, the resonators being placed opposite to each other, power can be wirelessly transmitted. The wireless power receiving section may be contained in the housing of the battery apparatus 100 or may be placed in the placement recessed portion 21. The wireless power transmitting section may be contained in the base 61 of the charger 200 or may be disposed at a position similar to that of the terminal portion 52 in FIG. 4. Also between the battery apparatus 100 and the electronic equipment 300, the transmission of power may be wireless power transmission in a similar manner.

Note that the embodiment described above is only an example for embodying the present disclosure and that the present disclosure can be implemented in various other forms. For example, many variations, replacements, omissions, or combinations thereof can be made without departing from the spirits of the present disclosure. The scope of the present disclosure and the invention recited in claims and the range of equivalency thereof include forms resulting from such variations, replacements, omissions, and the like.

Additionally, the effects of the present disclosure described herein are only illustrative and other effects may be produced.

Note that the present disclosure can have the following configurations.

[1]

A battery apparatus including:
a housing including a first exterior surface, a second exterior surface facing the first exterior surface, a third exterior surface and a fourth exterior surface provided between the first exterior surface and the second exterior surface and facing each other, and a fifth exterior surface and a sixth exterior surface provided between the first exterior surface and the second exterior surface and facing each other;
a terminal portion including a connection terminal connected to an electrode terminal of connection equipment;
a placement recessed portion provided in one of the third exterior surface and the fourth exterior surface and being open in a connection direction between the connection terminal and the electrode terminal, the terminal portion being placed in the placement recessed portion;
multiple first guide recessed portions provided in the one of the third exterior surface and the fourth exterior surface and being open in the connection direction;
a second guide recessed portion provided in the fifth exterior surface and being open in the connection direction; and
a third guide recessed portion provided in the sixth exterior surface and being open in the connection direction.
   [2]

The battery apparatus according to 1, in which
at least one of an opening area of the second guide recessed portion and an opening area of the third guide recessed portion increases in the connection direction.
   [3]

The battery apparatus according to 1 or 2, in which
an opening area of at least one of the multiple first guide recessed portions increases in the connection direction.
   [4]

The battery apparatus according to any one of 1 to 3, in which
the multiple first guide recessed portions are provided on opposite sides of the placement recessed portion.
   [5]

The battery apparatus according to any one of 1 to 4, in which
the connection equipment is a charger.
   [6]

A charger including:
an installation recessed portion including an installation surface in which a battery apparatus is installed, a first surface, a second surface, and a third surface at least partially surrounding the installation surface, the first surface being provided between the second surface and the third surface;
a terminal portion provided on the installation surface and including an electrode terminal being connectible to a connection terminal of the battery apparatus;
multiple first guide protruding portions provided on the first surface and having a longitudinal direction corresponding to a connection direction between the electrode terminal and the connection terminal;
a second guide protruding portion provided on the second surface and having a longitudinal direction corresponding to the connection direction; and
a third guide protruding portion provided on the third surface and having a longitudinal direction corresponding to the connection direction.
   [7]

The charger according to 6, in which
the multiple first guide protruding portions are provided on opposite sides of the terminal portion.
   [8]

The charger according to 6 or 7, in which
each of the second guide protruding portion and the third guide protruding portion is larger in length in the longitudinal direction than each of the multiple first guide protruding portions.
   [9]

Electronic equipment including:
a battery installation portion in which a battery apparatus is installable, in which
the battery installation portion includes
   an installation recessed portion including an installation surface in which the battery apparatus is installed, and a first surface, a second surface, and a third surface at least partially surrounding the installation surface, the first surface being provided between the second surface and the third surface,
   a terminal portion provided on the installation surface along the first surface and including an electrode terminal being connectible to a connection terminal of the battery apparatus,
   a first guide protruding portion provided on the second surface and having a longitudinal direction corresponding to a connection direction between the connection terminal and the electrode terminal, and
   a second guide protruding portion provided on the third surface and having a longitudinal direction corresponding to the connection direction.
      [10]

The electronic equipment according to 9, in which
the electronic equipment is a mobile body.
   [11]

The electronic equipment according to 9 or 10, in which
the mobile body is a drone.

### REFERENCE SIGNS LIST

11: Front surface
12: Rear surface
13: Left side surface
14: Right side surface
15: Upper surface
16: Lower surface
21: placement recessed portion
22: Opening portion
23: Connection terminal
24A and 24B: Guide recessed portion (first guide recessed portion)
26A: Opening portion
27: Terminal portion
28A: Recessed portion
31: Guide recessed portion (second guide recessed portion)
32: Opening portion
41: Guide recessed portion (third guide recessed portion)
42: Opening portion
51: Battery installation portion
51A: Installation recessed portion
52: Terminal portion
53: Electrode terminal
54A and 54B: Guide protruding portion (first guide protruding portion)
55: Guide protruding portion (second guide protruding portion)
56: Guide protruding portion (third guide protruding portion)
58A: Protruding portion
61: Base (housing)
61A: Installation surface
62: Left side portion
63: Right side portion
64: Rear surface portion
72: Left side portion
73: Right side portion
74: Mounting portion (base)
74A: Installation surface
75: Guide protruding portion (first guide protruding portion)
76: Guide protruding portion (second guide protruding portion)
82: Terminal portion
83: Electrode terminal
86: Rear surface portion
88A: Protruding portion
91: Battery installation portion
91A: Installation recessed portion
100: Battery apparatus
101: Housing (battery housing)
200: Charger
300: Electronic equipment

1. A battery apparatus comprising:
a housing including a first exterior surface, a second exterior surface facing the first exterior surface, a third exterior surface and a fourth exterior surface provided between the first exterior surface and the second exterior surface and facing each other, and a fifth exterior surface and a sixth exterior surface provided between the first exterior surface and the second exterior surface and facing each other;
a terminal portion including a connection terminal connected to an electrode terminal of connection equipment;
a placement recessed portion provided in one of the third exterior surface and the fourth exterior surface and being open in a connection direction between the connection terminal and the electrode terminal, the terminal portion being placed in the placement recessed portion;
multiple first guide recessed portions provided in the one of the third exterior surface and the fourth exterior surface and being open in the connection direction;
a second guide recessed portion provided in the fifth exterior surface and being open in the connection direction; and
a third guide recessed portion provided in the sixth exterior surface and being open in the connection direction.

2. The battery apparatus according to claim 1, wherein
at least one of an opening area of the second guide recessed portion and an opening area of the third guide recessed portion increases in the connection direction.

3. The battery apparatus according to claim 1, wherein
an opening area of at least one of the multiple first guide recessed portions increases in the connection direction.

4. The battery apparatus according to claim 1, wherein
the multiple first guide recessed portions are provided on opposite sides of the placement recessed portion.

5. The battery apparatus according to claim 1, wherein
the connection equipment is a charger.

6. A charger comprising:
an installation recessed portion including an installation surface in which a battery apparatus is installed, a first surface, a second surface, and a third surface at least partially surrounding the installation surface, the first surface being provided between the second surface and the third surface;
a terminal portion provided on the installation surface and including an electrode terminal being connectible to a connection terminal of the battery apparatus;
multiple first guide protruding portions provided on the first surface and having a longitudinal direction corresponding to a connection direction between the electrode terminal and the connection terminal;
a second guide protruding portion provided on the second surface and having a longitudinal direction corresponding to the connection direction; and
a third guide protruding portion provided on the third surface and having a longitudinal direction corresponding to the connection direction.

7. The charger according to claim 6, wherein
the multiple first guide protruding portions are provided on opposite sides of the terminal portion.

8. The charger according to claim 6, wherein
each of the second guide protruding portion and the third guide protruding portion is larger in length in the longitudinal direction than each of the multiple first guide protruding portions.

9. Electronic equipment comprising:
a battery installation portion in which a battery apparatus is installable, wherein
the battery installation portion includes
an installation recessed portion including an installation surface in which the battery apparatus is installed, and a first surface, a second surface, and a third surface at least partially surrounding the installation surface, the first surface being provided between the second surface and the third surface,
a terminal portion provided on the installation surface along the first surface and including an electrode terminal being connectible to a connection terminal of the battery apparatus,
a first guide protruding portion provided on the second surface and having a longitudinal direction corresponding to a connection direction between the connection terminal and the electrode terminal, and
a second guide protruding portion provided on the third surface and having a longitudinal direction corresponding to the connection direction.

10. The electronic equipment according to claim 9, wherein
the electronic equipment is a mobile body.

11. The electronic equipment according to claim 10, wherein
the mobile body is a drone.
